(19) United States
(12) Patent Application Publication
(10) Pub. No.: US 2025/0386239 A1
(43) Pub. Date: Dec. 18, 2025

(54) MONITORING METHOD AND DEVICE

(71) Applicant: GUANGDONG OPPO MOBILE TELECOMMUNICATIONS CORP., LTD., Dongguan (CN)

(72) Inventor: Jingran CHEN, Dongguan (CN)

(21) Appl. No.: 19/313,025

(22) Filed: Aug. 28, 2025

Related U.S. Application Data
(63) Continuation of application No. PCT/CN2023/089934, filed on Apr. 21, 2023.

(51) Int. Cl. H04W 28/02; H04W 28/06

(52) U.S. Cl. CPC H04W 28/0268; H04W 28/06

(57) ABSTRACT

Embodiments of the present application provide a monitoring method and a device, the monitoring method including: a first terminal sending a first data packet to a second terminal, a packet header of the first data packet including at least one of a first identifier and a first indicator. The first identifier is used to represent a QoS flow monitored by the first terminal, and the first indicator is used to indicate that the first data packet is used for monitoring QoS on PC5. In this way, monitoring QoS on PC5 between the first terminal and the second terminal can be realized.

### CROSS-REFERENCE TO RELATED APPLICATION

This application is a continuation application of International Patent Application No. PCT/CN2023/089934 filed on Apr. 21, 2023, the entire content of which is incorporated herein by reference.

### TECHNICAL FIELD

The disclosure relates to the field of communications, and particularly to a method and a device for monitoring.

### BACKGROUND

In communication systems, there exist Quality of Service (QOS) monitoring methods tailored to service requirements. How to realize QoS monitoring on PC5 is a technical problem that needs to be solved.

### SUMMARY

Embodiments of the disclosure provide methods and devices for monitoring, which can realize QoS monitoring on a PC5 interface.

A method for monitoring as provided in an embodiment of the disclosure includes the following operation.

A first terminal transmits a first packet to a second terminal, a packet header of the first packet including at least one of a first identifier or a first indication.

The first identifier is used for indicating a QoS flow monitored by the first terminal.

The first indication is used for indicating that the first packet is used for QoS monitoring on PC5.

A method for monitoring as provided in an embodiment of the disclosure includes the following operation.

A second terminal receives a first packet from a first terminal, a packet header of the first packet including at least one of a first identifier or a first indication.

The first identifier is used for indicating a QoS flow monitored by the first terminal.

The first indication is used for indicating that the first packet is used for QoS monitoring on PC5.

A method for monitoring as provided in an embodiment of the disclosure includes the following operations.

A first network element receives a first monitoring request, the first monitoring request including service flow description information and/or a monitored QoS type.

The first network element generates a first monitoring policy and/or a second monitoring policy based on the first monitoring request.

A method for monitoring as provided in an embodiment of the disclosure includes the following operations.

A second network element receives from a first terminal and/or a second terminal a QOS monitoring result on PC5.

The second network element aggregates the QoS monitoring result on the PC5 and a User Equipment (UE)-to-User Plane Function (UPF) QOS monitoring result to obtain a peer-to-peer QoS monitoring result.

A first terminal as provided in an embodiment of the disclosure includes a first transmitting module.

The first transmitting module is configured to transmit a first packet to a second terminal, a packet header of the first packet including at least one of a first identifier or a first indication.

The first identifier is used for indicating a QoS flow monitored by the first terminal.

The first indication is used for indicating that the first packet is used for QoS monitoring on PC5.

A second terminal as provided in an embodiment of the disclosure includes a third receiving module.

The third receiving module is configured to receive a first packet from a first terminal, a packet header of the first packet including at least one of a first identifier or a first indication.

The first identifier is used for indicating a QoS flow monitored by the first terminal.

The first indication is used for indicating that the first packet is used for QoS monitoring on PC5.

A first network element as provided in an embodiment of the disclosure includes a fourth receiving module and a generation module.

The fourth receiving module is configured to receive a first monitoring request, the first monitoring request including service flow description information and/or a monitored QoS type.

The generation module is configured to generate a first monitoring policy and/or a second monitoring policy based on the first monitoring request.

A second network element as provided in an embodiment of the disclosure includes a sixth receiving module and a second aggregation module.

The sixth receiving module is configured to receive from a first terminal and/or a second terminal a QOS monitoring result on PC5.

The second aggregation module is configured to aggregate the QoS monitoring result on the PC5 and a UE-to-UPF QOS monitoring result to obtain a peer-to-peer QoS monitoring result.

A communication device as provided in an embodiment of the disclosure includes a processor, a memory and a transceiver. The memory is configured to store a computer program, and the processor is configured to call the computer program stored in the memory and run the computer program to control the transceiver to implement the foregoing methods.

A chip as provided in an embodiment of the disclosure is configured to implement the foregoing methods.

Specifically, the chip includes a processor for calling a computer program from a memory and running the computer program, to cause a device installed with the chip to implement the foregoing methods.

A computer-readable storage medium as provided in an embodiment of the disclosure is configured to store a computer program that when run by a device, causes the device to implement the foregoing methods.

A computer program product as provided in an embodiment of the disclosure includes computer program instructions that cause a computer to execute the foregoing methods.

A computer program as provided in an embodiment of the disclosure causes a computer to execute the foregoing methods when running on a computer.

In the embodiments of the disclosure, the first terminal transmits the first packet to the second terminal, and carries a related identifier in the packet header of the first packet, which can implement QoS monitoring on PC5 between the first terminal and the second terminal.

### BRIEF DESCRIPTION OF THE DRAWINGS

FIG. 1 is a diagram of an application scenario according to an embodiment of the disclosure.

FIG. 2 exemplarily illustrates a diagram of a 5G network system architecture.

FIG. 3 exemplarily illustrates a flowchart of QoS monitoring.

FIG. 4 is a diagram of an architecture of Artificial Intelligence (AI)/Machine Learning (ML) participating in Proximity Service (ProSe).

FIG. 5 is a diagram of an architecture model using ProSe 5G UE-to-Network (U2N) relay.

FIG. 6 is a flowchart of an implementation of a monitoring method 600 according to an embodiment of the disclosure.

FIG. 7 is a diagram of an information interaction between a first terminal and a second terminal in a monitoring method according to an embodiment of the disclosure.

FIG. 8 is a flowchart of a terminal initiating QoS monitoring on PC5 according to the disclosure.

FIG. 9 is a flowchart of peer-to-peer QOS monitoring in a case of UE-to-Network (U2N) according to the disclosure.

FIG. 10 is another flowchart of peer-to-peer QOS monitoring in the case of the U2N according to the disclosure.

FIG. 11 is a flowchart of a monitoring method 1100 according to an embodiment of the disclosure.

FIG. 12 is a flowchart of a monitoring method 1200 according to an embodiment of the disclosure.

FIG. 13 is a flowchart of a monitoring method 1300 according to an embodiment of the disclosure.

FIG. 14 is a diagram of a structure of a first terminal 1400 according to an embodiment of the disclosure.

FIG. 15 is a diagram of a structure of a first terminal 1500 according to an embodiment of the disclosure.

FIG. 16 is a diagram of a structure of a second terminal 1600 according to an embodiment of the disclosure.

FIG. 17 is a diagram of a structure of a second terminal 1700 according to an embodiment of the disclosure.

FIG. 18 is a diagram of a structure of a first network element 1800 according to an embodiment of the disclosure.

FIG. 19 is a diagram of a structure of a first network element 1900 according to an embodiment of the disclosure.

FIG. 20 is a diagram of a structure of a second network element 2000 according to an embodiment of the disclosure.

FIG. 21 is a diagram of a structure of a second network element 2100 according to an embodiment of the disclosure.

FIG. 22 is a diagram of a structure of a communication device 2200 according to an embodiment of the disclosure.

FIG. 23 is a diagram of a structure of a chip 2300 according to an embodiment of the disclosure.

### DETAILED DESCRIPTION

The technical solution in embodiments of the disclosure will be described below in combination with the drawings in the embodiments of the disclosure.

It should be noted that the terms “first”, “second” and the like in the description and claims of the embodiments of the disclosure and the foregoing drawings are used to distinguish similar objects, and are not necessarily used to describe a specific order or sequence. The objects of the “first” and the “second” described simultaneously may be the same or different.

The technical solution in embodiments of the disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (NR) system, an evolution system of the NR system, an LTE-based access to unlicensed spectrum (LTE-U) system, a NR-based access to unlicensed spectrum (NR-U) system, a Non-Terrestrial Network (NTN) system, a Universal Mobile Telecommunications System (UMTS), a Wireless Local Area Network (WLAN), a Wireless Fidelity (WiFi), a 5th Generation (5G) system or other communication systems.

In general, traditional communication systems support a limited number of connections and are easy to implement. However, with the development of the communication technologies, mobile communication systems will not only support traditional communication, but also support, for example, Device to Device (D2D) communication, Machine to Machine (M2M) communication, Machine Type Communication (MTC), Vehicle to Vehicle (V2V) communication, or Vehicle to everything (V2X) etc. The embodiments of the disclosure can also be applied to these communication systems.

In an implementation, the communication systems in the embodiments of the disclosure may be applied to Carrier Aggregation (CA) scenarios, Dual Connectivity (DC) scenarios, or Standalone (SA) network deployment scenarios.

In an implementation, the communication systems in the embodiments of the disclosure can be applied to an unlicensed spectrum which can also be considered as a shared spectrum. Alternatively, the communication systems in the embodiments of the disclosure can also be applied to a licensed spectrum which can also be considered as a non-shared spectrum.

Each embodiment is described in conjunction with a network device and a terminal device in the embodiments of the disclosure. The terminal device may also be referred to as a user equipment (UE), an access terminal, a user unit, a user station, a mobile station, a remote station, a remote terminal, a mobile device, a user terminal, a terminal, a wireless communication device, a user agent or a user apparatus, or the like.

The terminal device may be a station (ST) in WLAN, which can be a cellular phone, a cordless phone, a Session Initiation Protocol (SIP) phone, a Wireless Local Loop (WLL) station, a Personal Digital Assistant (PDA) device, a handheld device having a wireless communication function, a computing device or other processing devices connected to a wireless modem, an on-board equipment, a wearable device, a terminal device in a next generation communication system such as an NR network, or a terminal device in a future evolved Public Land Mobile Network (PLMN), or the like.

In the embodiments of the disclosure, the terminal device may be arranged on land including indoor or outdoor areas, handheld, wearable or on-board. The terminal device may also be arranged on the water (such as on a ship). The terminal device may also be arranged on the air (such as on an airplane, a balloon, or a satellite).

In the embodiments of the disclosure, the terminal device may be a mobile phone, a tablet computer (or Pad), a computer with wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home, or the like.

As an example rather than a limitation, in the embodiments of the disclosure, the terminal device may also be a wearable device. The wearable device may also be referred to as a wearable intelligent device, which is a general name of wearable devices developed by intelligent designing for the daily wears with wearable technologies, such as glasses, gloves, watches, clothing and shoes. The wearable device is a portable device that is worn directly on the body or integrated into the user's clothes or accessories. The wearable device is not only a hardware device, but also a device realizing powerful functions through software support, data interaction and cloud interaction. Generalized wearable intelligent devices include: a device (such as intelligent watches or intelligent glasses) with full functions and large size, which can implement complete or partial functions without relying on an intelligent phone, and a device (such as various intelligent bracelets and intelligent jewelries for monitoring physical signs) which only focuses on a certain application function and is required to be used in conjunction with other devices such as smart phones.

In the embodiments of the disclosure, the network device may be a device for communicating with a mobile device, and the network device may be an Access Point (AP) in WLAN, a Base Transceiver Station (BTS) in GSM or CDMA, a NodeB (NB) in WCDMA, an Evolutional Node B (eNB or eNodeB) in LTE, a relay station or an AP, an on-board equipment or a wearable device, a gNB in an NR network, a network device in a future evolved PLMN network or a network device in a NTN.

As an example rather than a limitation, in the embodiments of the disclosure, the network device may have mobility, for example, the network device may be a mobile device. Optionally, the network device may be a satellite or a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, or the like. Optionally, the network device may also be a base station arranged on land, in water and the like.

In the embodiments of the disclosure, the network device may provide services for a cell, and the terminal device may communicate with the network device through transmission resources (such as frequency domain resources, also called spectrum resources) used by the cell. The cell may be a cell corresponding to the network device (e.g., a base station), and the cell may belong to a macro base station or a base station corresponding to a small cell. The small cell may be a metro cell, a micro cell, a pico cell, a femto cell, etc. These small cells have characteristics of small coverage and low transmission power, which are suitable for providing services of high-speed data transmission.

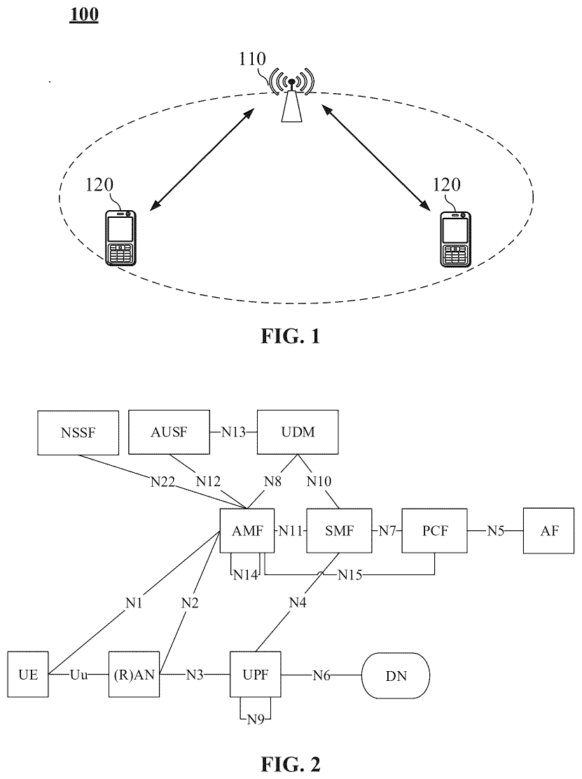

As an example, FIG. 1 exemplarily illustrates a communication system 100. The communication system includes one network device 110 and two terminal devices 120. In an implementation, the communication system 100 may include multiple network devices 110, and other numbers of terminal devices 120 may be included within the coverage area of each network device 110, which is not limited in the embodiments of the disclosure.

In an implementation, the communication system 100 may also include other network entities, such as a Mobility Management Entity (MME), an Access and Mobility Management Function (AMF), or the like, which is not limited in embodiments of the disclosure.

Herein, the network device may also include an access network device and a core network device. That is, the wireless communication system also includes multiple core networks for communicating with the access network device. The access network device may be an evolutional node B (eNB or e-NodeB for short), a macro base station, a micro base station (also referred to as a “small base station”), a pico base station, an access point (AP), a transmission point (TP) or a new generation Node B (gNodeB), or the like in a long-term evolution (LTE) system, a next generation (NR) system or an authorized auxiliary access long-term evolution (LAA-LTE) system.

It should be understood that a device having a communication function in the network/system in the embodiments of the disclosure may be referred to as a communication device. The communication system illustrated in FIG. 1 is taken as an example, the communication device may include the network device and the terminal device having communication functions, the network device and the terminal device may be specific devices in the embodiments of the disclosure and will not be elaborated herein. The communication device may further include other devices in the communication system, such as a network controller, a mobility management entity and other network entities, which is not limited in embodiments of the disclosure.

FIG. 2 exemplarily illustrates a diagram of a 5G network system architecture. Herein, UE may perform an access layer connection with an Access Network (AN) through a Uu interface to exchange access stratum messages and wireless data transmission, and the UE may perform a Non-Access Stratum (NAS) connection with an AMF through an N1 interface to exchange NAS messages. The AMF is a mobility management function in a core network, and an SMF is a session management function in the core network. In addition to the mobility management for the UE, the AMF is also responsible for forwarding session management related messages between the UE and the SMF. PCF is a policy management function in the core network, which is responsible for formulating policies related to the mobility management, the session management, billing, or the like for UE. UPF is a user plane function in the core network, and the UPF may perform data transmission with an external data network through an N6 interface and perform data transmission with the AN through an N3 interface.

It should be understood that terms “system” and “network” in the disclosure may usually be exchanged. In the disclosure, the term “and/or” is only used for describing an association relationship of associated objects, for example, the term “and/or” represents that three relationships may exist between previous and next associated objects. For example, A and/or B may represent three conditions: independent existence of A, existence of both A and B, and independent existence of B. Character “/” in the disclosure usually represents that an “or” relationship is formed between the previous and next associated objects.

It should be understood that the term “indication” mentioned in the embodiments of the disclosure may be a direct indication, may be an indirect indication, or may represent an association relationship. For example, A indicating B may represent that A directly indicates B, e.g., B can be obtained through A, may also represent that A indirectly indicates B, e.g., A indicates C, and B can be obtained through C, or may also represent that there is an association relationship between A and B.

In the description of the embodiments of the disclosure, the term “corresponding to” may represent that there is a direct correspondence or an indirect correspondence relationship between two elements, may also represent that there is an association relationship between the two elements, or may also be a relationship of indicating and being indicated, or configuration and being configured, etc.

For convenience of understanding of the technical solutions of the embodiments of the disclosure, related technologies in the embodiments of the disclosure are described. The following related technologies may be used as alternative solutions and may be combined with the technical solutions of the embodiments of the disclosure in various ways, all of which belong to the scope of protection of the embodiments of the disclosure.

### 1. Ultra Reliable and Low Latency Communication (URLLC) QOS Monitoring.

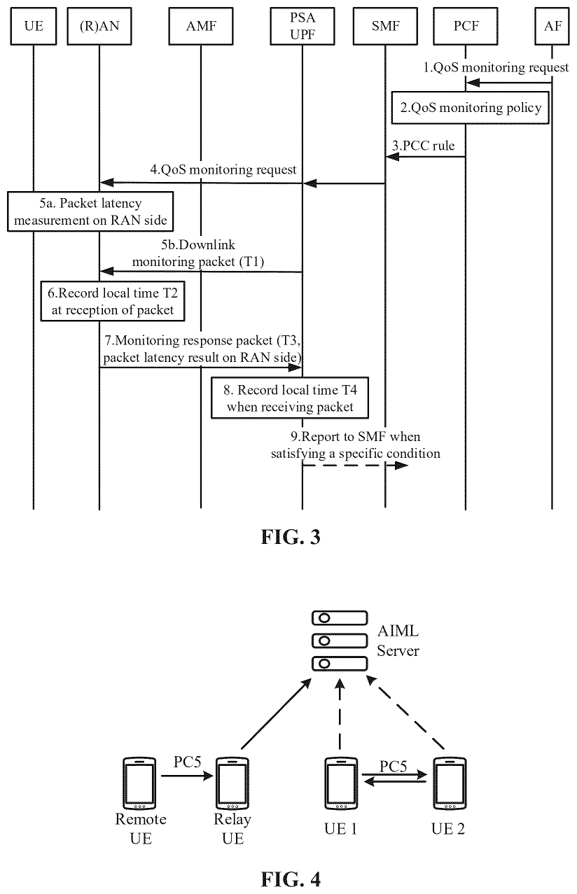

In an existing 5G system, there is a QoS monitoring method tailed to the requirements of URLLC services. The high QoS requirements of URLLC services are satisfied through real-time monitoring on a message latency. The QoS monitoring method in a core network at a flow granularity level is illustrated in FIG. 3, which includes the following processes.

At operations 1 to 3, in response to receiving a QOS monitoring request for a service data flow from the Application Function (AF), the Policy Control Function (PCF) generates an authorized QoS monitoring policy based on the QoS monitoring request for the service data flow. The PCF includes the authorized QoS monitoring policy into the Packet Data Unit (PDU) rule and transmits it to the Session Management Function (SMF). The SMF initiates UpLink (UL)/DownLink (DL) packet latency measurement between the UE and a PDU Session Anchor (PSA) User Plane Function (UPF) through a PDU session establishment or modification process.

At operation 4, the SMF transmits a QOS monitoring request to the PSA UPF via N4 signaling and a Next Generation Radio Access Network (NG-RAN) via N2 signaling.

At operation 5a, the NG-RAN initiates the RAN part of UL/DL packet latency measurement based on the QOS monitoring request, and reports the result to the PSA UPF in an uplink packet or a Dummy UL packet.

If the NG-RAN and PSA UPF are time synchronized, a one way packet latency monitoring is supported. If the NG-RAN and the PSA UPF are not time synchronized, it is assumed that the UL packet latency and the DL packet latency are the same.

At operation 5b, when the PSA UPF transmits a downlink monitoring packet, the PSA UPF encapsulates in a General Packet Radio System (GPRS) Tunnelling Protocol for User Plane (GTP-U) header with a QoS Flow Identifier (QFI), a QoS Monitoring Packet (QMP) indicator and a local time T1 at which a DL packet is transmitted.

At operation 6, the NG-RAN records the local time T1 received in the GTP-U header and the local time T2 at the reception of the DL monitoring packet.

At operation 7, when the NG-RAN receives an UL packet using the same QFI as the DL monitoring packet from UE or when the NG-RAN transmits a dummy UL packet as a monitoring response packet to the UPF (in case there is no UL service packet), the NG-RAN encapsulates the QMP indicator, the RAN part of UL/DL packet latency result, the times T1, T2 described above, and the local time T3 when the UL monitoring response packet is transmitted.

At operations 8 to 9, the PSA UPF records the local time T4 when receiving the monitoring response packet and calculates the round trip (if not time synchronized) or UL/DL packet latency (if time synchronized) between the NG-RAN and the UPF. If not time synchronised, the PSA UPF calculates the UL/DL latency based on the (T2−T1+T4−T3)/2. If time synchronised, the PSA UPF calculates the UL packet latency and DL packet latency based on (T4-T3) and (T2-T1), respectively. The PSA UPF calculates the UL/DL packet latency between UE and PSA UPF by adding the RAN part of UL/DL packet latency and the calculated UL/DL packet latency between RAN and PSA UPF. The PSA UPF reports the result to the SMF based on some specific condition, e.g., when a threshold for reporting to the SMF is reached.

In addition, the measurement of QOS is not limited to the measurement for the packet latency, and the UPF may also report information such as a rate (or a bit rate) to realize the measurement for the rate (or the bit rate).

### 2. The Terminal Participates in AI Training and Inference.

As the performance of cameras and sensors of mobile terminals continues to improve, more and more terminals can collect valuable training data essential for Artificial Intelligence (AI)/Machine Learning (ML) model training. For multiple AI/ML tasks, the small sample data collected by mobile terminals is of great significance for training a global model.

Taking Federated Learning (FL) as an example, an FL server may complete the training of a global model by aggregating local training results reported by each terminal. In each training iteration, the terminal can use local training data to perform training on the global model downloaded from the FL server, and then report intermediate training results (such as the gradient of Data Network Name (DNN)) to the FL server through a 5G uplink channel. The FL server then may aggregate the collected gradients and update the global model. The FL server may distribute the updated global model to the federated terminal through the 5G downlink channel, and the terminal may perform the next iterative training on the updated model.

Limited by the storage capabilities of UE, the UE cannot store all required AI models in advance. Therefore, when the UE needs to perform a certain AI service, such as picture recognition, the UE will download model data from a third-party application server. In order to ensure the user experience, one AI inference service needs to be completed within a relatively strict time. In addition, limited by the computing power of the UE, it is necessary to reserve enough time for the UE to complete the local inference of the model and obtain a result that the user wants. For example, if a user plans to complete the picture recognition within 1 s, considering the latency for the model to perform the inference on the UE side, the time for downloading the model needs to be in milliseconds.

### 3. Participating in AI/ML of Proximity Services (ProSe).

In a case that a terminal participating in the AI/ML cannot complete the entire local training due to issues with computing power or battery capability and other terminals also have the same model, the terminal may transmit the intermediate results that have been calculated to a certain step (such as a certain layer) to the other terminals, and the other terminals may complete subsequent calculations. In such a case, there may not be required to connect with a server. FIG. 4 is a diagram of an architecture of AI/ML participating in the ProSe. Data may be transmitted between UE1 and UE2 in FIG. 4. Alternatively, when a terminal leaves the coverage of a current base station or a federated server during the local calculation process due to mobility reasons, and the terminal cannot transmit training results to a server, the UE transmits the results to the server by means of ProSE, thereby ensuring that the AI/ML operations can be smoothly performed.

As illustrated in FIG. 4, a UE outside the coverage of the base station or the federated server is a remote UE, and a UE within the coverage of the base station or the federated server is a relay UE. The remote UE can transmit data by means of the relay UE.

### 4. ProSe Architecture

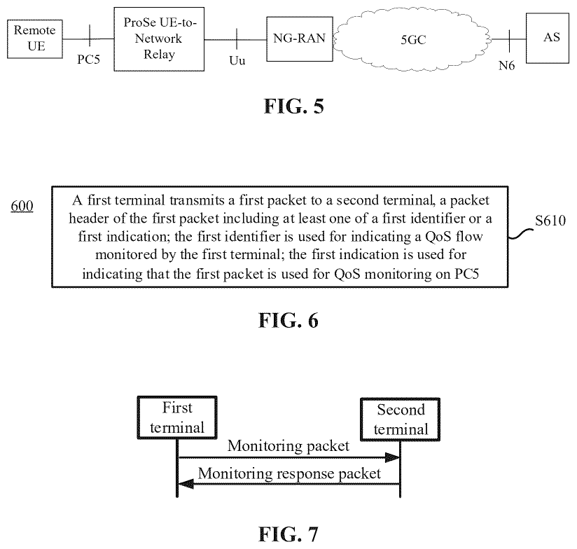

FIG. 5 is a diagram of an architecture model using ProSe 5G UE-to-Network (U2N) Relay. As illustrated in FIG. 5, a UE with a ProSe capability may communicate directly with another UE with a ProSe capability through PC5. When a UE can connect to an external data network through a 5G network and has a ProSe capability, this UE can act as a Relay UE. Another Remote UE with a ProSe capability can establish a direct connection with the Relay UE through the PC5, and then the Relay UE establishes a PDU session with the 5G network to interact with an external network.

The existing QoS monitoring method merely measures a QoS result between a UE and a UPF, but does not consider the measurement for QoS on PC5 when the ProSe is involved in an operation of AI/ML. However, the measurement for QoS on PC5 has important significances for the operation of the AI/ML. For example, when the UE1 offloads part of a training task to the UE2, the UE1 needs to know the real-time transmission latency and rate between the UE1 and the UE2, so as to determine how much task to offload to the UE2. When a UE acts as a relay UE to help another UE forward data to a server, the server needs to know a peer-to-peer QoS result, so as to determine whether the selected relay UE is suitable and whether the selected relay UE can ensure that the operation of the AI/ML is not affected. Therefore, it is of great significance to measure QoS on PC5, regardless for a terminal direct connection or a U2N Relay.

An embodiment of the disclosure proposes a monitoring method, and FIG. 6 is a flowchart of an implementation of a monitoring method 600 according to an embodiment of the disclosure. The method may be applied to any one of the systems illustrated in FIGS. 1 to 5, but is not limited thereto. The method includes at least part of the following contents.

At an operation S610, a first terminal transmits a first packet to a second terminal, a packet header of the first packet including at least one of a first identifier or a first indication.

The first identifier is used for indicating a QoS flow monitored by the first terminal.

The first indication is used for indicating that the first packet is used for QoS monitoring on PC5.

The QoS flow monitored by the first terminal may also be referred to as a QoS flow to be monitored by the first terminal. Herein, the QoS monitoring on the PC5 may include packet latency monitoring and/or rate monitoring. In some embodiments, the packet header of the first packet may further include first time information indicating a local time at which the first packet is transmitted.

The first terminal may further receive a second packet, the packet header of the second packet including at least one of the first identifier, the first indication, the first time information, second time information, or third time information.

The second time information indicates a local time at which the second terminal receives the first packet.

The third time information indicates a local time at which the second terminal transmits the second packet.

Thereafter, the first terminal may determine a packet latency on the PC5 based on at least one of the first time information, the second time information, the third time information, or fourth time information. The fourth time information indicates a local time at which the first terminal receives the second packet.

In some implementations, the first terminal may be a remote UE or a relay UE.

In some embodiments, the second terminal may also be a remote UE or a relay UE.

For example, the first terminal is a remote UE, and the second terminal is a relay UE. Alternatively, the first terminal is a relay UE, and the second terminal is a remote UE.

In an example, the first terminal may include an application layer and a ProSe layer.

In some embodiments, the first terminal transmits the first packet to the second terminal, which may include that: the application layer generates the first packet; and the ProSe layer adds at least one of the first identifier or the first indication into the packet header of the first packet.

The first packet to which the first identifier and/or the first indication are added may be transmitted to the second terminal through a physical channel.

In some embodiments, the monitoring method may further include the following operations.

The application layer transmits a monitoring request to the ProSe layer.

The ProSe layer updates a PC5 QOS rule based on the monitoring request.

In this way, when it is required to transmit an application layer packet later, the ProSe layer can correctly identify the packet, and add a corresponding identifier (such as at least one of the first identifier or the first indication) into the packet header of the packet. The packet header of the packet may further include first time information, or the like.

In an example, the monitoring request includes at least one of a monitored QoS type or service flow description information. For example, the service flow description information, including such as five-tuple information or the like, may be used to identify a QoS flow. The monitored QoS type may also be referred to as a QoS type to be monitored or a QoS parameter type to be monitored. For example, the monitored QoS type may be used to indicate that what is to be monitored is a packet latency or a rate.

In an example, the first packet includes a monitoring packet, and the second packet includes a monitoring response packet.

FIG. 7 is a diagram of an information interaction between a first terminal and a second terminal in the monitoring method according to an embodiment of the disclosure. As illustrated in FIG. 7, the first terminal transmits the monitoring packet to the second terminal, and the second terminal returns the monitoring response packet to the first terminal. The first terminal may calculate a QoS monitoring result on the PC5 based on the information carried in the monitoring response packet and/or the local time at which the first terminal receives the monitoring response packet. The QoS monitoring result may include a packet latency on the PC5 between the first terminal and the second terminal. In addition, the QoS monitoring result may further include a rate on the PC5. Herein, the QoS monitoring result on the PC5 may also be referred to as a QoS monitoring result on a PC5 interface. The packet latency on the PC5 may also be referred to as a packet latency on a PC5 interface. The rate on the PC5 may also be referred to as a rate on a PC5 interface, and the rate may include a transmission rate. The first terminal or the second terminal can collect packets within a period of time, count the number of collected packets, and calculate the rate on the PC5 (or the PC5 interface) based on a size of each packet. In this way, QoS monitoring on the PC5 (or the PC5 interface) can be implemented.

In some embodiments, the first terminal may further transmit the QoS monitoring result on the PC5.

For example, the first terminal periodically transmits the QoS monitoring result on the PC5; and/or the first terminal transmits the QoS monitoring result on the PC5 when the QOS monitoring result on the PC5 satisfies a preset condition.

For example, when the packet latency on the PC5 is greater than, less than or equal to a preset latency threshold, the first terminal transmits the packet latency on the PC5. Optionally, when the rate of the first terminal on the PC5 is greater than, less than or equal to a preset rate threshold, the first terminal transmits the rate on the PC5.

The monitoring method proposed in the embodiments of the disclosure can be applied to the QOS measurement of the PC5 in a case of terminal direct connection, or can be applied to QoS measurement of the peer-to-peer in a case of U2N.

In some embodiments, the monitoring method may further include that the first terminal receives a first monitoring policy. In an example, the first monitoring policy includes a QoS monitoring policy for the PC5. Before transmitting the first packet, the first terminal may receive the first monitoring policy from a first network element which may be a core network element such as a PCF or the like. The first monitoring policy may include service flow description information and/or a monitored QoS type. The first terminal may update a PC5 QoS rule based on the first monitoring policy. After updating the PC5 QOS rule, when an application layer packet is to be transmitted, the first terminal may correctly identify the packet, and add a corresponding identifier, including such as at least one of the first identifier, the second identifier, or the first time information, into the packet header of the packet.

Herein, the first identifier may include a PC5 QOS flow Identifier (PFI).

The first indication may include a PC5 QOS Monitoring Packet (PQMP) indication.

Hereinafter, specific embodiments will be described in detail with reference to the accompanying drawings.

### First Embodiment

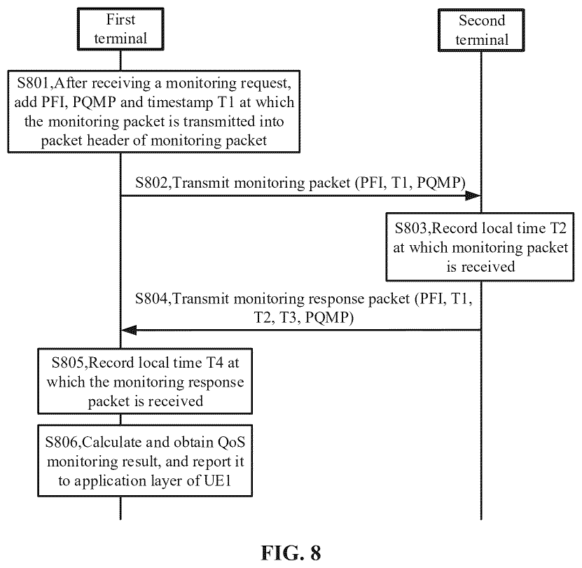

The embodiment is mainly aimed at the case of terminal direct connection. Exemplarily, taking UE1 as an example, when a first terminal (such as UE1) plans to offload part of task to a second terminal (such as UE2), the first terminal needs to know a QoS monitoring value on the PC5 between the first terminal and the second terminal, and then the first terminal may initiate QoS monitoring on the PC5. The foregoing scenario is merely an example, the embodiment of the disclosure can support the QOS monitoring on the PC5 in any one of the other scenarios. FIG. 8 is a flowchart of a terminal initiating QoS monitoring on the PC5 according to the disclosure, which includes the following operations.

At the operation 0, when the application layer of the first terminal (such as UE1) plans to measure the latency on the PC5, the application layer of the first terminal transmits a monitoring request to the ProSe layer of the first terminal, and the monitoring request may include a monitored QoS type and/or service flow description information. Based on the monitoring request, the ProSe layer may update the PC5 QOS rule. After this operation, when it is required to transmit an application layer packet, the first terminal can correctly identify the packet and add the corresponding identifier into the packet header of the packet.

At the operation S801, according to the operation 0, when the ProSe layer of the first terminal receives the monitoring packet from the application layer, the ProSe layer of the first terminal may add PFI and PQMP into the packet header of the monitoring packet. Herein, the PFI is a PC5 QOS flow Identifier, which indicates a QoS flow monitored by the first terminal (or a QoS flow to be monitored). The PQMP is a PC5 QOS monitoring packet, which indicates that the packet is used for performing the QoS monitoring on the PC5. In addition, if the QoS monitoring is packet latency monitoring, the ProSe layer of the first terminal may also add the local time T1 at which the monitoring packet is transmitted into the packet header.

At the operation S802, the first terminal transmits the monitoring packet to the second terminal.

At the operation S803, after receiving the monitoring packet, the second terminal determines that the packet is the monitoring packet based on the PQMP. Thus, the second terminal records the transmission time T1 of the monitoring packet and the local time T2 at which the monitoring packet is received.

At the operation S804, the second terminal transmits a monitoring response packet to the first terminal, and writes PFI, PQMP, T1, T2 and local time T3 at which the monitoring response packet is transmitted into the header of the monitoring response packet.

At the operation S805, the first terminal receives the monitoring response packet, and records the local time T4 at which the monitoring response packet is received.

At the operation S806, the first terminal calculates and obtains the packet latency on the PC5 based on T1 to T4. For example, in a case of non-synchronization, the first terminal calculates the packet latency on the PC5 by (T2−T1+T4−T3)/2. In a case of synchronization, the first terminal calculates packet latencies in different directions on the PC5 by (T4−T3) and (T2−T1), respectively. In addition, if the rate of the packet on the PC5 is to be monitored, the first terminal or the second terminal may calculate the rate on the PC5 based on the size of each of packets collected over a period of time, where the rate may include the transmission rate on the PC5.

The first terminal or the second terminal may periodically or conditionally transmit the QoS monitoring result on the PC5 to the application layer of the first terminal. For example, only when the QoS result satisfies a certain threshold, the first terminal or the second terminal transmits the QoS monitoring result on the PC5 to the application layer of the first terminal.

### Second Embodiment

The embodiment mainly focuses on the peer-to-peer QOS measurement in the case of U2N. In the embodiment, when it is required for an AF to know a peer-to-peer latency to determine whether a Relay UE can satisfy an AI/ML operation, the AF may first transmit a first monitoring request to a PCF, and the first monitoring request may include service flow description information and/or a monitored QoS type. Herein, the service flow description information, including such as five-tuple information or the like, may be used to identify a QoS flow. The monitored QoS type may also be referred to as a QoS type to be monitored or a QoS parameter type to be monitored. For example, the monitored QoS type may be used to indicate that what is to be monitored is a packet latency or a rate.

The first monitoring request may include a peer-to-peer QoS monitoring request. The PCF may generate a peer-to-peer QoS monitoring policy (e.g., including a first monitoring policy and/or a second monitoring policy) based on the first monitoring request. The first monitoring policy may include a QoS monitoring policy for the PC5, and the second monitoring policy may include a QoS monitoring policy for the UE-to-UPF. Herein, the first monitoring policy may include the service flow description information and/or the monitored QoS type.

The PCF may transmit the QoS monitoring policy for the PC5 to a Relay UE and/or a Remote UE. The Remote UE and/or the Relay UE may perform QoS monitoring between UEs, and the specific monitoring procedure may refer to the method illustrated in the first embodiment. The first terminal in the first embodiment may be the Remote UE or the Relay UE. The QoS monitoring between UEs may be performed only by the Remote UE, or the QoS monitoring between UEs may be performed only by the Relay UE, or the QoS monitoring between UEs may be performed by the Remote UE and the Relay UE, respectively. The PCF may also transmit the QoS monitoring policy for the UE-to-UPF (for example, the QoS monitoring policy for the UE-to-UPF is carried through a Policy and Charging Control (PCC) rule) to the SMF, and the SMF may initiate a QOS monitoring request for the UE-to-UPF.

After performing QOS monitoring on the PC5, the remote UE and/or the relay UE may report the QoS monitoring result on the PC5 to the PCF or the PSA UPF. The PCF or PSA UPF may aggregate the QoS monitoring result on the PC5 and the QoS monitoring result for the UE (relay UE)-to-UPF to obtain a total peer-to-peer QoS monitoring value.

FIG. 9 is a flowchart of peer-to-peer QOS monitoring in a case of U2N according to the disclosure. In the example illustrated in FIG. 9, the QoS monitoring result on the PC5 and the QoS monitoring result for the UE (relay UE)-to-UPF are aggregated by the PCF. As illustrated in FIG. 9, the method includes the following operations S901 to S911.

At the operation S901, when an AF plans to know a peer-to-peer QoS value, the AF transmits a peer-to-peer QOS monitoring request to the PCF, where the request includes a QoS type to be monitored (for example, a rate or a packet latency, or the like) and service flow description information.

At the operation S902, the PCF generates a peer-to-peer QoS monitoring policy, including a QOS monitoring policy for the UE-to-UPF and a QoS monitoring policy for the PC5.

At the operation S903, the PCF transmits the QOS monitoring policy for the UE-to-UPF to the SMF, for example, the PCF carries the QoS monitoring policy for the UE-to-UPF in the PCC rule and transmits it to the SMF.

At the operation S904, based on the QoS monitoring policy for the UE-to-UPF, the SMF transmits a QoS monitoring request to the PSA UPF and the RAN, respectively.

At the operation S905, the PSA UPF calculates a QOS monitoring result for the UE-to-UPF (e.g., a packet latency for the UE-to-UPF).

At the operation S906, the PSA UPF transmits the QOS monitoring result for the UE-to-UPF to the PCF.

At the operation S907, the PCF transmits the generated QoS monitoring policy for the PC5 to the relay UE and/or the remote UE. The QoS monitoring policy for the PC5 includes service flow description information, a monitored QoS type, or the like.

At the operation S908, the remote UE and/or the relay UE update(s) the PC5 QoS rule based on the QOS monitoring policy for the PC5, and perform(s) QoS monitoring on the PC5. For a specific monitoring method, reference can be made to the method described in the first embodiment. For example, the remote UE and/or the relay UE may act as the first terminal in the first embodiment, to initiate QoS monitoring on the PC5. The remote UE and/or the relay UE may act as the second terminal in the first embodiment, to receive the monitoring packet of the first terminal, and feed back the monitoring response packet to the first terminal to complete the QoS monitoring on the PC5.

At the operation S909, the relay UE and/or the remote UE transmit(s) the QoS monitoring result on the PC5 to the PCF.

At the operation S910, the PCF aggregates the QoS monitoring result for the UE-to-UPF obtained in the operation S906 and the QoS monitoring result on the PC5 obtained in the operation S909 to obtain a final peer-to-peer QoS monitoring result.

At the operation S911, the PCF transmits the peer-to-peer QoS monitoring result to the AF. When transmitting the peer-to-peer QoS monitoring result, the PCF may periodically transmit the peer-to-peer QoS monitoring result, or transmit the peer-to-peer QoS monitoring result when the peer-to-peer QoS monitoring result satisfies a predetermined condition.

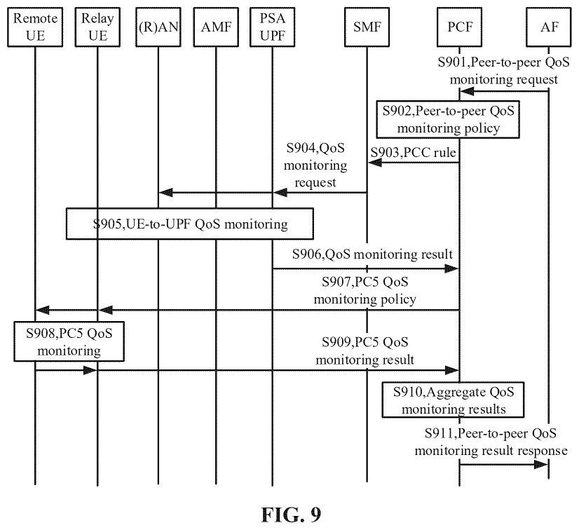

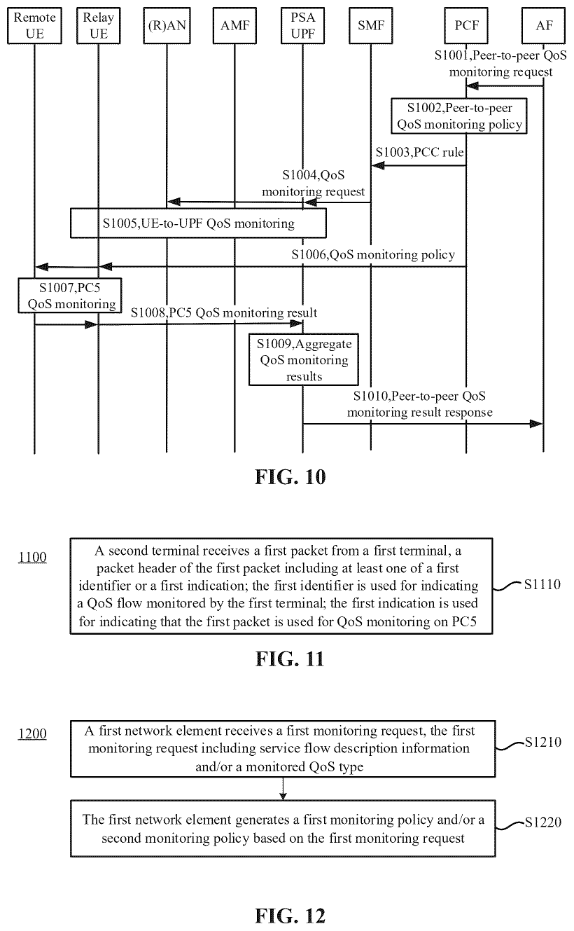

FIG. 10 is another flowchart of peer-to-peer QOS monitoring in the case of U2N according to the disclosure. In the example illustrated in FIG. 10, the PSA UPF aggregates the QOS monitoring result on the PC5 and the QoS monitoring result for the UE (relay UE)-to-UPF. As illustrated in FIG. 10, the method includes the following operations S1001 to S1010.

At the operation S1001, when an AF plans to know a peer-to-peer QoS value, the AF transmits a peer-to-peer QoS monitoring request to the PCF, where the request includes a QoS type to be monitored (for example, a rate or a packet latency, or the like) and service flow description information.

At the operation S1002, the PCF generates a peer-to-peer QoS monitoring policy, including a QoS monitoring policy for the UE-to-UPF and a QoS monitoring policy for the PC5.

At the operation S1003, the PCF transmits the QOS monitoring policy for the UE-to-UPF to the SMF, for example, the PCF carries the QoS monitoring policy for the UE-to-UPF in the PCC rule and transmits it to the SMF.

At the operation S1004, based on the QoS monitoring policy for the UE-to-UPF, the SMF transmits a QoS monitoring request to the PSA UPF and the RAN, respectively.

At the operation S1005, the PSA UPF calculates a QOS monitoring result for the UE-to-UPF (e.g., packet latency for the UE-to-UPF).

At the operation S1006, the PCF transmits the generated QoS monitoring policy for the PC5 to the relay UE and/or the remote UE. The QoS monitoring policy for the PC5 includes service flow description information, a monitored QoS type, or the like.

At the operation S1007, the remote UE and/or the relay UE update(s) the PC5 QOS rule based on the QoS monitoring policy for the PC5, and perform(s) QoS monitoring on the PC5. For a specific monitoring method, reference can be made to the method described in the first embodiment. For example, the remote UE and/or the relay UE may act as the first terminal in the first embodiment, to initiate QoS monitoring on the PC5. The remote UE and/or the relay UE may act as the second terminal in the first embodiment, to receive the monitoring packet of the first terminal, and feed back the monitoring response packet to the first terminal to complete the QoS monitoring on the PC5.

At the operation S1008, the relay UE and/or the remote UE transmit(s) the QoS monitoring result on the PC5 to the PSA UPF.

At the operation S1009, the PSA UPF aggregates the QoS monitoring result for the UE-to-UPF obtained in the operation S1005 and the QoS monitoring result on the PC5 obtained in the operation S1008 to obtain a final peer-to-peer QOS monitoring result.

At the operation S1010, the PSA UPF transmits the peer-to-peer QoS monitoring result to the AF (e.g., through the PCF). When transmitting the peer-to-peer QoS monitoring result, the PSA UPF may periodically transmit the peer-to-peer QoS monitoring result, or transmit the peer-to-peer QoS monitoring result when the peer-to-peer QoS monitoring result satisfies a predetermined condition.

In the monitoring method provided in the embodiments of the disclosure, QoS monitoring on PC5 is added, which enables a UE or an AF to accurately know a QoS value on the PC5 and a total peer-to-peer QoS value. In an AI/ML application, the UE or the AF can be enabled to accurately determine the amount of tasks to be offloaded and whether a selected Relay UE is suitable for performing operations of the AI/ML, thereby more efficiently supporting services for the application layer AI/ML.

In the embodiments of the disclosure, for QOS monitoring on PC5, a new indication (i.e., PQMP) is introduced and a UE adds the indication and timestamps into a packet header, thereby supporting a QoS measurement between UEs. For a U2N scenario, in the embodiments of the disclosure, by introducing a new peer-to-peer QOS monitoring request, an PCF generates a QoS monitoring policy between the UE and a UPF as well as a QoS monitoring policy between UEs, and performs QoS monitoring for each segment, respectively. The PCF or the PSA UPF QOS aggregates a monitoring result of each segment to obtain the final peer-to-peer monitoring result.

The monitoring method proposed in the embodiments of the disclosure is not limited to a 5G system. In B5G or 6G networks that introduce AI functions, the same mechanism can also be applied to enable a UE and an AF to know a QoS value on PC5 and a peer-to-peer QoS value, thereby better supporting a third-party AI/ML application.

An embodiment of the disclosure further proposes a monitoring method. FIG. 11 is a flowchart of a monitoring method 1100 according to an embodiment of the disclosure, which can be applied to any one of the systems illustrated in FIGS. 1 to 5, but is not limited thereto. The method includes at least part of the following contents.

At an operation S1110, a second terminal receives a first packet from a first terminal, a packet header of the first packet including at least one of a first identifier or a first indication.

The first identifier is used for indicating a QoS flow monitored by the first terminal.

The first indication is used for indicating that the first packet is used for QoS monitoring on PC5.

Herein, the QoS flow monitored by the first terminal may also be referred to as a QoS flow to be monitored by the first terminal.

In some embodiments, the packet header of the first packet may further include first time information indicating a local time at which the first packet is transmitted.

In some embodiments, the method may further include the following operation.

The second terminal may transmit a second packet to the first terminal, a packet header of the second packet including at least one of the first identifier, the first indication, the first time information, second time information, or third time information.

The second time information indicates a local time at which the second terminal receives the first packet.

The third time information indicates a local time at which the second terminal transmits the second packet.

By receiving the first packet from the first terminal and feeding back the second packet to the first terminal, QoS monitoring on the PC5 between the first terminal and the second terminal can be supported.

In some embodiments, the first identifier may include a PFI.

In some embodiments, the first indication may include a PQMP indication.

In some embodiments, the first terminal may be a remote UE or a relay UE.

In some embodiments, the second terminal may be a remote UE or a relay UE.

In some embodiments, the first packet may include a monitoring packet.

In some embodiments, the second packet may include a monitoring response packet.

An embodiment of the disclosure further proposes a monitoring method. FIG. 12 is a flowchart of a monitoring method 1200 according to an embodiment of the disclosure, which can be applied to any one of the systems illustrated in FIGS. 1 to 5, but is not limited thereto. The method includes at least part of the following contents.

At an operation S1210, the first network element receives a first monitoring request, the first monitoring request including service flow description information and/or a monitored QoS type.

At an operation S1220, the first network element generates a first monitoring policy and/or a second monitoring policy based on the first monitoring request.

The first monitoring request is used for generating the first monitoring policy and/or the second monitoring policy.

In some embodiments, the first monitoring request may include a peer-to-peer QOS monitoring request.

In some embodiments, the first monitoring policy may include a QoS monitoring policy for PC5.

In some embodiments, the first monitoring policy may include service flow description information and/or a monitored QoS type.

In some embodiments, the second monitoring policy may include a UE-to-UPF

QOS monitoring policy.

In some embodiments, the method may further include the following operation.

The first network element may transmit the first monitoring policy to a first terminal and/or a second terminal.

In some embodiments, the method may further include the following operations.

The first network element may receive a QoS monitoring result on the PC5 from the first terminal and/or the second terminal.

The first network element may aggregate the QoS monitoring result on the PC5 and the QoS monitoring result for the UE-to-UPF to obtain a peer-to-peer QoS monitoring result.

In some embodiments, the method may further include at least one of the following operations.

The first network element may periodically transmit the peer-to-peer QoS monitoring result.

The first network element may transmit the peer-to-peer QoS monitoring result when the peer-to-peer QoS monitoring result satisfies a preset condition.

In some embodiments, the first terminal may be a remote UE or a relay UE.

In some embodiments, the second terminal may be a remote UE or a relay UE.

In some embodiments, the first network element may include a PCF.

The method supports that the core network element generates a QoS monitoring policy between a UE and a UPF and a QoS monitoring policy between UEs, thereby supporting the execution of QOS monitoring for each segment, respectively. By aggregating a QoS monitoring result of each segment, a final peer-to-peer monitoring result can be obtained.

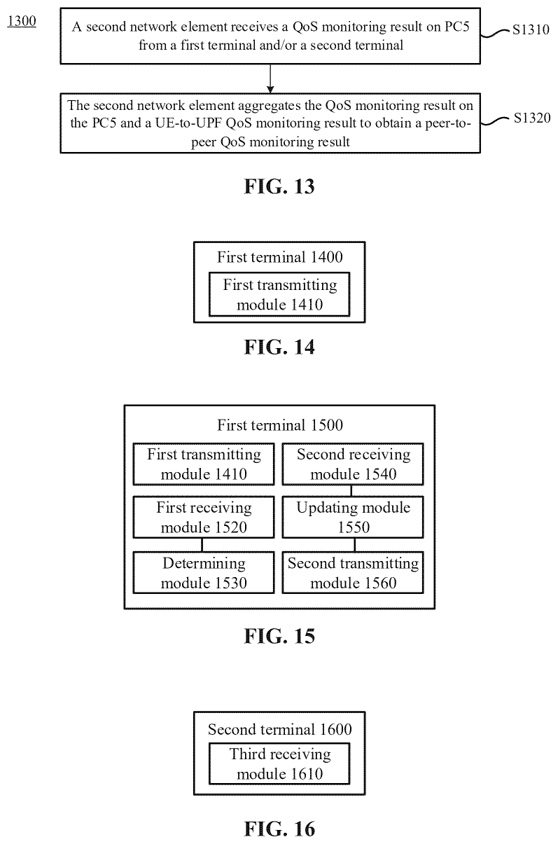

An embodiment of the disclosure further proposes a monitoring method. FIG. 13 is a flowchart of a monitoring method 1300 according to an embodiment of the disclosure, which can be applied to any one of the systems illustrated in FIGS. 1 to 5, but is not limited thereto. The method includes at least part of the following contents.

At an operation S1310, a second network element receives a QoS monitoring result on PC5 from a first terminal and/or a second terminal.

At an operation S1320, the second network element aggregates the QoS monitoring result on the PC5 and a UE-to-UPF QOS monitoring result to obtain a peer-to-peer QoS monitoring result.

In some embodiments, the first terminal may be a remote UE or a relay UE.

In some embodiments, the second terminal may be a remote UE or a relay UE.

In some embodiments, the method may further include at least one of the following operations.

The second network element may periodically transmit the peer-to-peer QoS monitoring result.

The second network element may transmit the peer-to-peer QoS monitoring result when the peer-to-peer QoS monitoring result satisfies a preset condition.

In some embodiments, the second network element may include a PSA UPF.

This method supports that the PSA UPF aggregates the QoS monitoring result of each segment, thereby obtaining a final peer-to-peer monitoring result.

An embodiment of the disclosure further proposes a first terminal. FIG. 14 is a diagram of a structure of a first terminal 1400 according to an embodiment of the disclosure, which includes a first transmitting module.

The first transmitting module 1410 is configured to transmit a first packet to a second terminal, a packet header of the first packet including at least one of a first identifier or a first indication.

The first identifier is used for indicating a QoS flow monitored by the first terminal.

The first indication is used for indicating that the first packet is used for QoS monitoring on PC5.

In some embodiments, the packet header of the first packet may further include first time information indicating a local time at which the first packet is transmitted.

FIG. 15 is a diagram of a structure of a first terminal 1500 according to an embodiment of the disclosure. The first terminal 1500 includes one or more features in the embodiments of the first terminal 1400 described above. In a possible implementation, in an embodiment of the disclosure, the first terminal 1500 further includes a first receiving module 1520.

The first receiving module 1520 is configured to receive a second packet, a packet header of the second packet including at least one of the first identifier, the first indication, the first time information, second time information, or third time information.

The second time information indicates a local time at which the second terminal receives the first packet.

The third time information indicates a local time at which the second terminal transmits the second packet.

In some embodiments, the first terminal 1500 may further include a determining module 1530.

The determining module 1530 is configured to determine a packet latency on the PC5 based on at least one of the first time information, the second time information, the third time information, or fourth time information.

The fourth time information indicates a local time at which the first terminal receives the second packet.

In some embodiments, the first terminal 1500 may further include a second receiving module 1540.

The second receiving module 1540 is configured to receive a first monitoring policy.

In some embodiments, the first monitoring policy includes a QoS monitoring policy for the PC5.

In some embodiments, the first monitoring policy may include service flow description information and/or a monitored QoS type.

In some embodiments, the first terminal 1500 may further include an updating module 1550.

The updating module 1550 is configured to update a PC5 QOS rule based on the first monitoring policy.

In some embodiments, the first terminal 1500 may further include a second transmitting module 1560, for transmitting a QoS monitoring result on the PC5.

In some embodiments, the QOS monitoring result on the PC5 may include at least one of: a packet latency on the PC5, or a rate on the PC5.

In some embodiments, the second transmitting module 1560 is configured to: periodically transmit the QOS monitoring result on the PC5; and/or transmit the QoS monitoring result on the PC5 when the QoS monitoring result on the PC5 satisfies a preset condition.

In some embodiments, the first identifier may include a PFI.

In some embodiments, the first indication may include a PQMP indication.

In some embodiments, the first terminal may be a remote UE or a relay UE.

In some embodiments, the second terminal may be a remote UE or a relay UE.

In some embodiments, the first packet may include a monitoring packet.

In some embodiments, the second packet may include a monitoring response packet.

In some embodiments, the first terminal may include an application layer and a ProSe layer.

The application layer may be configured to generate the first packet.

The ProSe layer may be configured to add at least one of a first identifier and a first indication into the packet header of the first packet.

In some implementations, the application layer may be further configured to transmit a monitoring request to the ProSe layer.

The ProSe layer may be further configured to update a PC5 QOS rule based on the monitoring request.

In an example, the monitoring request includes at least one of a monitored QoS type or service flow description information. For example, the service flow description information, including such as five-tuple information or the like, may be used to identify a QoS flow. The monitored QoS type may also be referred to as the QoS type to be monitored or the QOS parameter type to be monitored. For example, the monitored QoS type may be used to indicate that what is to be monitored is the packet latency or rate.

It should be understood that the above-described and other operations and/or functions of the modules in the first terminal according to the embodiment of the disclosure aim to implement the corresponding flow of the first terminal in the method 600 of FIG. 6, respectively, which are not repeated herein for sake of brevity.

An embodiment of the disclosure further proposes a second terminal. FIG. 16 is a diagram of a structure of a second terminal 1600 according to an embodiment of the disclosure, which includes a third receiving module 1610.

The third receiving module 1610 is configured to receive a first packet from a first terminal, a packet header of the first packet including at least one of a first identifier or a first indication.

The first identifier is used for indicating a QoS flow monitored by the first terminal.

The first indication is used for indicating that the first packet is used for QoS monitoring on PC5.

In some embodiments, the packet header of the first packet may further include first time information indicating a local time at which the first packet is transmitted.

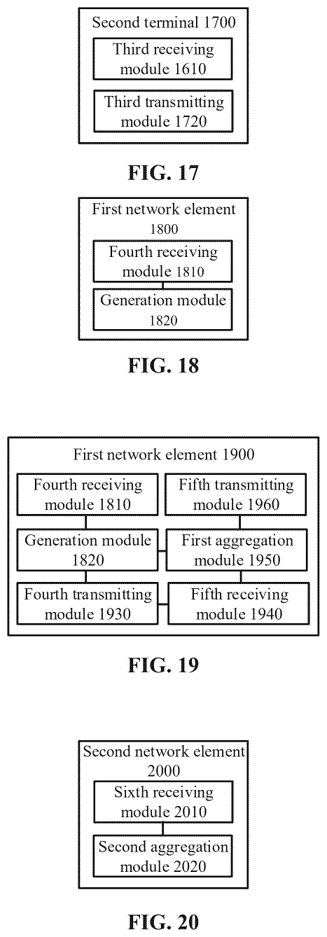

FIG. 17 is a diagram of a structure of a second terminal 1700 according to an embodiment of the disclosure. The second terminal 1700 includes one or more features in the embodiments of the second terminal 1600 described above. In a possible implementation, in an embodiment of the disclosure, the second terminal 1700 further includes a third transmitting module 1720.

The third transmitting module 1720 is configured to transmit a second packet to the first terminal, where a packet header of the second packet includes at least one of the first identifier, the first indication, the first time information, second time information, or third time information.

The second time information indicates a local time at which the second terminal receives the first packet.

The third time information indicates a local time at which the second terminal transmits the second packet.

In some embodiments, the first identifier may include a PFI.

In some embodiments, the first indication may include a PQMP indication.

In some embodiments, the first terminal may be a remote UE or a relay UE.

In some embodiments, the second terminal may be a remote UE or a relay UE.

In some embodiments, the first packet may include a monitoring packet.

In some embodiments, the second packet may include a monitoring response packet.

It should be understood that the above-described and other operations and/or functions of the modules in the second terminal according to the embodiment of the disclosure aim to implement the corresponding flow of the first terminal in the method 1100 of FIG. 11, respectively, which are not repeated herein for sake of brevity.

An embodiment of the disclosure further proposes a first network element. FIG. 18 is a diagram of a structure of a first network element 1800 according to an embodiment of the disclosure, which includes a fourth receiving module 1810 and a generation module 1820.

The fourth receiving module 1810 is configured to receive a first monitoring request, the first monitoring request including service flow description information and/or a monitored QoS type.

The generation module 1820 is configured to generate a first monitoring policy and/or a second monitoring policy based on the first monitoring request.

In some embodiments, the first monitoring request may include a peer-to-peer QOS monitoring request.

In some embodiments, the first monitoring policy may include a QoS monitoring policy for PC5.

In some embodiments, the first monitoring policy may include service flow description information and/or a monitored QoS type.

In some embodiments, the second monitoring policy may include a UE-to-UPF QOS monitoring policy.

FIG. 19 is a diagram of a structure of a first network element 1900 according to an embodiment of the disclosure. The first network element 1900 includes one or more features in the embodiments of the first network element 1800 described above. In a possible implementation, in an embodiment of the disclosure, the first network element 1900 further includes a fourth transmitting module 1930.

The fourth transmitting module 1930 is configured to transmit a first monitoring policy to a first terminal and/or a second terminal.

In some embodiments, the first network element 1900 may further include a fifth receiving module 1940 and a first aggregation module 1950.

The fifth receiving module 1940 is configured to receive a QoS monitoring result on the PC5 from the first terminal and/or the second terminal.

The first aggregation module 1950 is configured to aggregate the QoS monitoring result on the PC5 and the UE-to-UPF QOS monitoring result to obtain a peer-to-peer QoS monitoring result.

In some embodiments, the first network element 1900 may further include a fifth transmitting module 1960.

The fifth transmitting module 1960 is configured to periodically transmit the peer-to-peer QoS monitoring result; and/or transmit the peer-to-peer QoS monitoring result when the QoS monitoring result on the PC5 satisfies a preset condition.

In some embodiments, the first terminal may be a remote UE or a relay UE.

In some embodiments, the second terminal may be a remote UE or a relay UE.

In some embodiments, the first network element may include a PCF.

It should be understood that the above-described and other operations and/or functions of the modules in the first network element according to the embodiment of the disclosure aim to implement the corresponding flow of the first network element in the method 1200 of FIG. 12, respectively, which is not repeated herein for sake of brevity.

An embodiment of the disclosure further proposes a second network element. FIG. 20 is a diagram of a structure of a second network element 2000 according to an embodiment of the disclosure, which includes a sixth receiving module 2010 and a second aggregation module 2020.

The sixth receiving module 2010 is configured to receive a QoS monitoring result for PC5 from a first terminal and/or a second terminal.

The second aggregation module 2020 is configured to aggregate the QoS monitoring result on the PC5 and a UE-to-UPF QOS monitoring result to obtain a peer-to-peer QOS monitoring result.

In some embodiments, the first terminal may be a remote UE or a relay UE.

In some embodiments, the second terminal may be a remote UE or a relay UE.

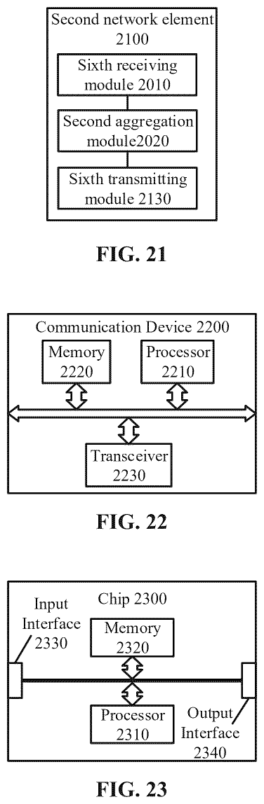

FIG. 21 is a diagram of a structure of a second network element 2100 according to an embodiment of the disclosure. The second network element 2100 includes one or more features in the embodiments of the second network element 2000 described above. In a possible implementation, in an embodiment of the disclosure, the second network element 2100 further includes a sixth transmitting module 2130.

The sixth transmitting module 2130 is configured to: periodically transmit the peer-to-peer QoS monitoring result; and/or transmit the peer-to-peer QoS monitoring result when the QoS monitoring result on the PC5 satisfies a preset condition.

In some embodiments, the second network element may include a PSA UPF.

It should be understood that the above-described and other operations and/or functions of the modules in the second network element according to the embodiment of the disclosure aim to implement the corresponding flow of the second network element in the method 1300 of FIG. 13, respectively, which are not repeated herein for sake of brevity.

It should be noted that the functions described by each module (sub-module, unit or component, etc.) in the communication device of the embodiment of the disclosure may be realized by different modules (sub-module, unit or component, etc.) or by a same module (sub-module, unit or component, etc.). For example, the first receiving module and the second receiving module may be different modules or a same module, and both of them may realize corresponding functions in the embodiments of the disclosure. In addition, the transmitting module and the receiving module in the embodiments of the disclosure may be realized by a transceiver of the device, and part of or all of the other modules may be realized by a processor of the device.

FIG. 22 is a diagram of a structure of a communication device 2200 according to an embodiment of the disclosure. The communication device 2200 illustrated in FIG. 22 includes a processor 2210, and the processor 2210 can call and run a computer program from a memory to implement the methods in the embodiments of the disclosure.

In some implementations, as illustrated in FIG. 22, the communication device 2200 may further include a memory 2220. Herein, the processor 2210 may call and run a computer program from the memory 2220 to implement the methods in the embodiments of the disclosure.

The memory 2220 may be a separate device independent of the processor 2210 or may be integrated into the processor 2210.

In some embodiments, as illustrated in FIG. 22, the communication device 2200 may further include a transceiver 2230. The processor 2210 may control the transceiver 2230 to communicate with other devices. Specifically, the transceiver 2230 may transmit information or data to other devices or receive information or data transmitted by other devices.

The transceiver 2230 may include a transmitter and a receiver. The transceiver 2230 may further include antennas, and the number of the antennas may be one or more.

In some embodiments, the communication device 2200 may be the communication device of the embodiments of the disclosure, and the communication device 2200 may implement corresponding processes implemented by the communication device in the various methods according to the embodiments of the disclosure, which is not repeated herein for sake of brevity.

FIG. 23 is a diagram of a structure of a chip 2300 according to an embodiment of the disclosure. The chip 2300 illustrated in FIG. 23 includes a processor 2310. The processor 2310 can call and run computer programs from a memory to implement the method in the embodiments of the disclosure.

In some embodiments, as illustrated in FIG. 23, the chip 2300 may further include a memory 2320. The processor 2310 can call and run the computer program from the memory 2320 to implement the method in the embodiments of the disclosure.

The memory 2320 may be a separate device independent of the processor 2310 or may be integrated into the processor 2310.

In some embodiments, the chip 2300 may further include an input interface 2330. The processor 2310 may control the input interface 2330 to communicate with other devices or chips, and in particular to obtain information or data transmitted by other devices or chips.

In some embodiments, the chip 2300 may further include an output interface 2340. The processor 2310 may control the output interface 2340 to communicate with other devices or chips, and in particular to output information or data to other devices or chips.

In some embodiments, the chip may be applied to the communication device in the embodiments of the disclosure, and the chip may implement the corresponding processes implemented by the communication device in various methods according to the embodiments of the disclosure, which is not repeated herein for sake of brevity.

It should be noted that the chip mentioned in the embodiments of the disclosure may also be referred to as a system level chip, a system chip, a chip system or an on-chip system chip, or the like.

The above processor may be a general purpose processor, a digital signal processor (DSPS), an application specific integrated circuit (ASIC), a field programmable gate array (FPGA) or other programmable logic devices, discrete gates or transistor logic devices, and discrete hardware components. The above general purpose processor may be a microprocessor or the processor may be any conventional processor or the like.

The memory in the embodiments of the disclosure may be a volatile memory or a non-volatile memory, or may include both a volatile and a non-volatile memory. The non-volatile memory can be a read-only memory (ROM), a programmable ROM (PROM), an erasable PROM (EPROM), an electrically EPROM (EEPROM) or a flash memory. The volatile memory can be a random access memory (RAM).

It should be noted that the memory described above is exemplary, but not limiting. For example, the memory in the embodiments of the disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM), etc. It is to be noted that the memory in the embodiments of the disclosure is intended to include, but is not limited to, memories of these and any other suitable type.

In the above embodiments, it may be implemented in whole or in part by software, hardware, firmware or any combination thereof. When implemented by software, it can be implemented in whole or in part in the form of a computer program product. The computer program product includes one or more computer instructions. When the computer program instructions are loaded and executed on a computer, the processes or functions described in accordance with the embodiments of the disclosure is generated in whole or in part. The computer may be a general purpose computer, a specific computer, a computer network, or other programmable devices. The computer instructions may be stored in a computer-readable storage medium or transmitted from computer-readable storage medium to another computer-readable storage medium. For example, the computer instructions may be transmitted from one Web site, computer, server, or data center via wired (e.g. coaxial cable, optical fiber, Digital Subscriber Line (DSL)) or wireless (e.g. infrared, wireless, microwave, etc.) to another Web site, computer, server, or data center. The computer-readable storage medium may be any available medium accessible to a computer or a data storage device, such as a server containing one or more usable media integration, data center, etc. The available medium may be a magnetic medium (e.g. floppy disk, hard disk, magnetic tape), an optical medium (e.g. DVD), or a semiconductor medium (e.g. Solid State Disk (SSD)), etc.

It should be understood that in various embodiments of the disclosure, the size of the sequence numbers of the above-mentioned processes does not mean an execution order, and the execution order of each process should be determined by its function and inherent logic, and should not be limited in any way to the implementation process of the embodiments of the disclosure.

Those skilled in the art will clearly appreciate that, for convenience and conciseness of description, the specific operating processes of the above-described systems, devices and units may refer to the corresponding processes in the aforementioned embodiments corresponding to the methods and will not be elaborated herein.

The above is only the specific embodiments of the disclosure, but the scope of protection of the disclosure is not limited to this. Any modifications and variations that can be easily known by the person skilled in the art within the scope of protection of the disclosure shall be covered in the scope of protection of the disclosure. Therefore, the scope of protection of the disclosure shall be subject to the scope of protection of the claims.

1. A method for monitoring, comprising:
transmitting, by a first terminal, a first packet to a second terminal, a packet header of the first packet comprising at least one of a first identifier or a first indication;
wherein the first identifier is used for indicating a Quality of Service (QOS) flow monitored by the first terminal; and
the first indication is used for indicating that the first packet is used for QoS monitoring on PC5.

2. The method of claim 1, wherein the packet header of the first packet further comprises first time information, the first time information indicating a local time at which the first packet is transmitted.

3. The method of claim 2, further comprising:
receiving, by the first terminal, a second packet, a packet header of the second packet comprising at least one of the first identifier, the first indication, the first time information, second time information, or third time information,
wherein the second time information indicates a local time at which the second terminal receives the first packet, and the third time information indicates a local time at which the second terminal transmits the second packet.

4. The method of claim 3, further comprising:
determining, by the first terminal, a packet latency on the PC5 based on at least one of: the first time information, the second time information, the third time information, or fourth time information,
wherein the fourth time information indicates a local time at which the first terminal receives the second packet.

5. The method of claim 1, further comprising:
receiving, by the first terminal, a first monitoring policy,
wherein the first monitoring policy comprises at least one of: a QoS monitoring policy for the PC5, service flow description information, or a monitored QoS type.

6. The method of claim 1, further comprising:
transmitting, by the first terminal, a QOS monitoring result on the PC5,
wherein the QoS monitoring result on the PC5 comprises at least one of:
a packet latency on the PC5; or
a rate on the PC5.

7. A first terminal, comprising: a processor, a memory and a transceiver, wherein the memory is configured to store a computer program, and the processor is configured to call the computer program stored in the memory and run the computer program to control the transceiver to transmit a first packet to a second terminal,
wherein a packet header of the first packet comprises at least one of a first identifier or a first indication,
wherein the first identifier is used for indicating a Quality of Service (QOS) flow monitored by the first terminal, and the first indication is used for indicating that the first packet is used for QoS monitoring on PC5.

8. The first terminal of claim 7, wherein the packet header of the first packet further comprises first time information, the first time information indicating a local time at which the first packet is transmitted.

9. The first terminal of claim 8, wherein the first terminal is further caused to receive a second packet, wherein a packet header of the second packet comprises at least one of: the first identifier, the first indication, the first time information, second time information, or third time information,
wherein the second time information indicates a local time at which the second terminal receives the first packet; and
the third time information indicates a local time at which the second terminal transmits the second packet.

10. The first terminal of claim 9, wherein the first terminal is further caused to determine a packet latency on the PC5 based on at least one of: the first time information, the second time information, the third time information, or fourth time information,
wherein the fourth time information indicates a local time at which the first terminal receives the second packet.

11. The first terminal of claim 7, wherein the first terminal is further caused to receive a first monitoring policy,
wherein the first monitoring policy comprises at least one of: a QoS monitoring policy for the PC5, service flow description information, or a monitored QoS type.

12. The first terminal of claim 7, wherein the first terminal is further caused to transmit a QoS monitoring result on the PC5,
wherein the QoS monitoring result on the PC5 comprises at least one of:
a packet latency on the PC5; or
a rate on the PC5.

13. The first terminal of claim 12, wherein transmitting the QoS monitoring result on the PC5 by the first terminal comprises at least one of following operations:
periodically transmitting the QoS monitoring result on the PC5; or
transmitting the QoS monitoring result on the PC5 when the QoS monitoring result on the PC5 satisfies a preset condition.

14. The first terminal of claim 7, wherein at least one of following manners is adopted for the packet header of the first packet:
the first identifier comprises a PC5 QoS Flow Identifier (PFI); or
the first indication comprises a PC5 QOS Monitoring Packet (PQMP) indication.

15. The first terminal of claim 7, wherein the first terminal comprises an application layer and a Proximity Service (ProSe) layer,
wherein transmitting, by the first terminal, the first packet to the second terminal comprises:
generating, by the application layer, the first packet; and
adding, by the ProSe layer, at least one of the first identifier or the first indication into the packet header of the first packet.

16. The first terminal of claim 15, wherein the first terminal is further caused to:
transmit, through the application layer, a monitoring request to the ProSe layer; and
update, through the ProSe layer, a PC5 QOS rule based on the monitoring request,
wherein the monitoring request comprises at least one of a monitored QoS type or service flow description information.

17. A second terminal, comprising: comprising: a processor, a memory and a transceiver, wherein the memory is configured to store a computer program, and the processor is configured to call the computer program stored in the memory and run the computer program to control the transceiver to receive a first packet from a first terminal,
wherein a packet header of the first packet comprises at least one of a first identifier or a first indication,
wherein the first identifier is used for indicating a Quality of Service (QOS) flow monitored by the first terminal, and the first indication is used for indicating that the first packet is used for QoS monitoring on PC5.

18. The second terminal of claim 17, wherein the packet header of the first packet further comprises first time information indicating a local time at which the first packet is transmitted.

19. The second terminal of claim 18, wherein the second terminal is further caused to transmit a second packet to the first terminal,
wherein a packet header of the second packet comprises at least one of: the first identifier, the first indication, the first time information, second time information, or third time information,
wherein the second time information indicates a local time at which the second terminal receives the first packet, and the third time information indicates a local time at which the second terminal transmits the second packet.

20. The second terminal of claim 17, wherein at least one of following manners is adopted for the packet header of the first packet:
the first identifier comprises a PC5 QoS Flow Identifier (PFI), or,
the first indication comprises a PC5 QOS Monitoring Packet (PQMP) indication.
